(19) United States
(12) Patent Application Publication
(10) Pub. No.: US 2024/0245008 A1
(43) Pub. Date: Jul. 25, 2024

(54) METHOD AND APPARATUS FOR PROCESSING PLANTS

(71) Applicant: ROBOTEC PTC GMBH, Bremen (DE)

(72) Inventors: Stephan VON RUNDSTEDT, Bremen (DE); Friederike VON RUNDSTEDT, Bremen (DE); Adrian LEU, Bremen (DE)

(73) Assignee: ROBOTEC PTC GMBH, Bremen (DE)

(21) Appl. No.: 18/565,654

(22) PCT Filed: May 6, 2022
(86) PCT No.: PCT/EP2022/062285

§ 371 Date: Dec. 22, 2023

(30) Foreign Application Priority Data
May 31, 2021 (DE) 10 2021 114 014.5

(51) Int. Cl. A01G 2/32; A01C 1/06; A01G 2/10; A01G 7/04; A01G 7/06

(52) U.S. Cl. CPC A01G 2/32; A01C 1/06; A01G 2/10; A01G 7/045; A01G 7/06

(57) ABSTRACT

An apparatus and a method for processing plants includes an apparatus for processing at least one plant has at least one conveyor device for transporting the plant, at least one image recognition device, at least one gripping means for the targeted depositing of the plant on the conveyor device, and at least one processing means for processing the plant lying on the conveyor device.

The invention relates to an apparatus for processing plants according to claim 1. Furthermore, the invention relates to a method for processing plants according to claim 11.

Plants, such as ornamental and crop plants, can be propagated and processed almost fully automatically. The increasing requirement for plants and also plant and organic material means that the demand for ornamental and crop plants has increased rapidly in recent years. There is therefore great interest in industrializing both the propagation and the processing of individual plants in order to be able to work particularly efficiently in terms of costs and time.

In known methods, individual plants can be grasped, detected by an image recognition device and then processed or cut by a processing means for propagation purposes. The use of costly personnel can be virtually completely dispensed with in this vegetative propagation method or cloning of plants. Although the known methods can produce a high-quality result, the quantity of processed plants achievable by these methods is relatively small. In particular for the further industrialization of plant processing, the previous processing rate using semi- or fully automated methods is insufficient.

The invention is therefore based on the object of providing an apparatus and a method for processing plants by means of which the processing of plants can be carried out efficiently in terms of time and costs.

This object is achieved by the features of claim 1. Accordingly, it is provided that an apparatus for processing at least one plant has at least one conveyor device for transporting the plant, at least one image recognition device, at least one gripping means for the targeted depositing of the plant on the conveyor device, and at least one processing means for processing the plant lying on the conveyor device. In the case of the invention described here, preferably ornamental plants, such as bedding and balcony plants, but also crop plants, such as fruit trees, hemp or potatoes, are intended to be processed. In addition, it is of course conceivable that further plants can also be processed according to the invention described here. By means of the targeted depositing of the plant on the conveyor device, the subsequent processing of the plant by the processing means can be undertaken particularly efficiently in terms of time.

In the case of known apparatuses, the plant was processed by the processing device while being held in position. This means that the gripping means for holding the plant, which may be, for example, a gripper or tweezers, is occupied during the processing process and cannot perform any further function. The shifting of the processing of the plant onto the conveyor device affords the advantage that the gripping means, after depositing the plant on the conveyor device, can already grasp the next plant and deposit same on the conveyor device. Since the plant has already been deposited in a targeted manner on the conveyor device, no further gripping means or fixation of the plant on the conveyor device is required. The plant can be processed lying on the conveyor device. As a result, a multiplicity of plants lying on the conveyor device can be processed simultaneously or promptly successively, while the at least one gripping means deposits further plants or plant components on the conveyor device. By using this apparatus, the process of crop cultivation can be accelerated, which also makes it possible to reduce the costs of the process at the same time.

Provision may be made, in a particularly preferred exemplary embodiment of the invention, for the image recognition device to have at least one camera, preferably two, three or more cameras, for recording a 2D or 3D image of the plant, and wherein the image recognition device has a neural network, by which the plant as well as individual components and features of the plant can be recognized and, on the basis of the recognized patterns and features of the plant, said plant can be deposited in a targeted manner on the conveyor device by the gripping means and can be processed by the processing means. The use of artificial intelligence (AI) makes it possible to determine individual features and patterns of the plant or plant components very precisely. Up to now, this task could only be carried out by people, since each plant is individually formed and therefore the automatic determination of suitable processing positions was possible only highly imprecisely, if at all. Through the use of neural networks, the apparatus or the image recognition device can be trained for any plant in such a way that the positions on the plant that are particularly suitable for processing can be determined precisely with a high degree of accuracy. In particular because of the high throughput rate of processed plants, the neural network is continuously trained and thereby improved even further. Once these suitable positions have been determined, the plant can be deposited on the surface of the conveyor precisely in such a way that it is particularly easily reachable for the processing means. This can increase both the processing speed and the processing accuracy.

Preferably, it is furthermore provided that the processing means has at least one tool, namely scissors, a scalpel, a hot wire, a laser beam, a plasma jet, a water jet, tweezers, pliers, a spatula or the like, wherein the tool is selectively movable three-dimensionally, in particular by a robot arm. The robot arm makes it possible to bring the tool precisely into the position which was determined by the neural network as being particularly suitable for processing the plant. For example, the processing means can be used to cut the plant for propagation purposes. Similarly, it is conceivable for only components of a plant to be separated by pliers. In addition, it is conceivable for the plant to be exposed to electromagnetic radiation of a certain wavelength by the processing means in order to accelerate the growth.

Another advantageous embodiment of the invention may make provision for the conveyor device to be a belt conveyor, in particular a wire belt conveyor, a steel or metal wire belt conveyor, wherein the material of the conveyor preferably reflects electromagnetic radiation and/or is permeable for a fluid. In particular, when a laser is used as a processing means, it is essential that the conveyor device is not destroyed by the irradiation with the laser. Even when using a scalpel or a plasma jet, care must be taken to ensure that the conveyor device is not damaged during use of the tools mentioned. At the same time, however, it is also important that the conveyor device can be at least regularly sterilized. Therefore, a wire belt conveyor is particularly suitable for the method described here.

In particular, the invention makes provision for the processing means, in particular the tool, to be movable at the same time relative to, in particular in synchronism with, the conveyor device, wherein the relative speed of the tool to the plant during the processing of the plant is 0 m/s. During this at least short-term synchronized movement of the tool with the plant, same is followed up by the robot arm precisely in such a way that the processing can be carried out on the plant. As a rule, the processing takes only a few seconds or even only a fraction of a second, and therefore the synchronized movement needs to be maintained only for a short time. At the same time, it is also conceivable for the conveyor device to be briefly stopped so that the processing can be carried out. The synchronized relative movement between the plant and the tool is controlled by the control unit. The control unit takes into consideration the position of the plant on the conveyor device, the speed of the conveyor device and the starting position of the processing means. In addition, the processing to be carried out on the plant is taken into consideration.

Furthermore, it is conceivable according to the invention that the processing means is a laser, the focus of which can be concentrated on the plant transported on the conveyor device. The laser itself thus maintains its position, while only the focus follows the movement of the plant. This can be achieved, for example, by a mirror system, wherein the mirrors are movably mounted and controllable in such a way that the focus is always on the region of the plant. The arrangement of the plurality of mirrors can be located along the entire conveyor device, so that the laser can reach the plant at any location on the conveyor device.

Preferably, provision can furthermore be made that a plurality of, preferably different, processing means are arranged on the conveyor device in order to carry out successive processing steps on the plant and/or to simultaneously process a plurality of plants in parallel. It is conceivable that, especially for the latter option, different tools can be used for the processing of the plant. These tools can be assigned to different processing means or different robot arms, which process the plant successively. At the same time, it is conceivable for the robot arms to be equipped with identical tools and for a plurality of plants deposited on the conveyor device to be simultaneously processed by one processing means each. This parallel processing of a plurality of plants enables the entire process to be made particularly efficient in terms of time. For the successive processing of the plant with different tools, it is particularly advantageous that the plant lies continuously on the conveyor device. This means that the plant does not need to be grasped and aligned again for each further processing step. This also allows a significant amount of time to be saved.

It is conceivable that at least one further gripping means is arranged at one end of the conveyor device in order to grasp the processed plant or a component of the plant in a targeted manner and to carry out a further processing step. It may also be provided, for example, that the processed plant is grasped and fed to a culture medium. It is also conceivable for the plant or the component of a plant to be moved by the gripping means in order to be further processed.

Preferably, the invention can make provision for the apparatus to have a sterile or non-sterile processing space in which the at least one conveyor device, the at least one image recognition device, the at least one gripping means and the at least one processing means are arranged, wherein the sterile processing space has at least one introduction lock and at least one discharge lock, depending on the processing to be undertaken with a sterile environment being absolutely required or not being required. For non-critical processing steps, it is conceivable for the apparatus described here to stand open in a room and to be exposed to the ambient air. Alternatively, it is also conceivable for the entire apparatus to be enclosed in a room with a sterile atmosphere and to be regularly cleaned accordingly.

It may also be useful for this purpose that a plurality of parallel conveyor devices, which can be operated at the same or different speeds, each transport at least one plant, which can be simultaneously processed by a plurality of processing means. This makes it possible for the method to be carried out at different speeds on different conveyor devices depending on the plant and depending on the processing to be carried out. It is also conceivable for the plant or the plant component to be moved from one conveyor device to another with a different conveyor speed during the processing. For example, plant components for which there is no further use can be moved onto a fast conveyor in order to remove this waste as quickly as possible from the working region, while the rest of the plant is still being processed further.

A method for achieving the object mentioned at the beginning comprises the measures of claim 11. Accordingly, the invention makes provision for at least one plant to be detected by an image recognition device and for said image recognition device to recognize patterns and features of the plant. In addition, a gripping means deposits the at least one plant in a targeted manner on a conveyor device for transporting the plant. An essential core of the invention consists in that the at least one plant is then processed lying on the conveyor device by at least one processing means. By means of the prior detection of patterns and features of the plant by the image recognition device, not only can the plant be deposited in a targeted manner, but can also be immediately processed in a targeted manner by the processing means. This makes it possible to save one process step in the entire method for processing the plant. Where the plant was previously processed hanging from the gripper, this is now done on the conveyor device. This has the consequence that the gripping means is already free to feed another plant to the image recognition device or to deposit same on the conveyor device. By shifting the processing onto the conveyor device, the entire method can thus be made much more efficient in terms of time and costs.

The invention also makes provision that, in addition to individual plants or a plurality of plants or cuttings, “carpets” of (in vitro) plants are also detected from above by the image recognition device and then processed accordingly. Processing could involve cutting into individual pieces. Similarly, the invention comprises the processing of potted plants or planting-out trays. Here, too, it may be provided that the image recognition device detects the plants and analyzes them and then individual head cuttings are processed or pinched off in a targeted manner with a tool, preferably cutting tweezers, which in particular may also be sterilized. The individual processed or pinched-off components can then be deposited on a separate conveyor device.

Preferably, the invention makes further provision for images of the plant to be recorded by at least one camera of the image recognition device, and for a neural network on the basis of said images to be used to determine positions on the plant at which processing, preferably preselected by a person, by the processing means can be carried out particularly efficiently, wherein the plant is held by the gripping means during the recording of the images or is already lying on the conveyor device. The artificial intelligence (AI)-based detection of the plant or of positions that are particularly suitable for the processing of the plant not only allows the method to be automated, but also achieves a very high degree of accuracy. An optional pre-selection by a person of manner of processing enables the AI or the neural network to search precisely for the positions on the plant that are suitable for said pre-selected processing. Similarly, it is also conceivable that the processing is not preselected, and the AI specifies different processing options for a person on the basis of the detected patterns or features. Depending on the application or concept, the position on the plant is determined in the held or lying state of the latter.

In particular, it is also conceivable for the plant to be deposited on the conveyor device by the gripping means, depending on the position determined by the neural network, specifically in such a way that the plant can be processed directly and optimally by the processing means. The gripping means, which may be tweezers, a suction cup or the like, is fastened to a robot arm, which is freely movable three-dimensionally. After determination of the optimum processing position on the plant, the latter is precisely deposited onto the conveyor device in such a way that the plant can be processed directly by the processing means in the following step. If the plant cannot be optimally deposited in one step, it is also conceivable that, in a second step, the gripping means will pick up the plant again and reposition it so that the processing means can undertake the processing.

Another exemplary embodiment of the invention makes provision for a plurality of gripping means to deposit plants simultaneously on the conveyor device. This allows the plurality of plants to be processed one after the other or simultaneously by one or more processing means.

Another exemplary embodiment of the invention may make provision for a plurality of plants to be deposited by the gripping means next to one another on the conveyor device, depending on the positions determined by the neural network, specifically in such a way that the plurality of plants can be processed directly and optimally in one process step by the processing means. In one possible exemplary embodiment, the plants are placed next to one another in such a way that, for example, a laser or a scalpel with one cut cuts a plurality of plants simultaneously. Similarly, a plurality of plants arranged adjacent to one another can be simultaneously exposed to electromagnetic radiation to stimulate growth, for example. This targeted depositing and the collective treatment of a plurality of plants makes the entire process much more efficient than previously. This embodiment may also make provision for sorting of the individual plants to take place on the conveyor device and for the plants to be processed in groups by the processing means.

The invention may also make provision that, after the processing of the plant or the multiplicity of plants by the one processing means or more than one processing means, the at least one plant or the components are sorted by means of the image recognition device, the neural network and/or the algorithm. It is thus conceivable that, for example, base pieces remain in a sterile area and are transported to sterile cups with culture media for further in vitro propagation. Cuttings, for example at a defined length (head or stem cuttings), can be transported out of the sterile area and plugged into a plug system, in particular into an automated product form, a gardening tray with e.g. soil substrate/plugs. Similarly, it is conceivable for the individual plants and/or the components of the plants to be sorted in general or specifically according to their shape, size, length, number of leaves, quality, color and other qualitative and quantitative properties. In particular by deposit or transport of the plants or the components on the conveyor device, the image recognition-based sorting process has proven particularly efficient in terms of time. The sorting means that the subsequent processes are also carried out very efficiently in terms of time and therefore costs. The at least one gripping means is used for moving or sorting the plants. A plurality of conveyor devices can also be used for the sorting process. Additional sorting means, such as containers, magazines, boxes, cartons, etc. can also be used.

A particularly advantageous exemplary embodiment of the present invention may make provision for the conveyor device to be assigned two, three or more, in particular different, processing means and for a plant which is transported on the conveyor device to be processed successively by the processing means. By assigning a plurality of processing means to the conveyor device, it is possible to carry out a plurality of successive processing steps on the plant. Cutting a plant or separating a clone, and then irradiating the cutting surface, in order, for example, to stimulate growth or to sterilize the cutting surface, is mentioned here as an example. In addition, further processing steps which are carried out successively on the plant are conceivable. Here, too, it is conceivable for a plurality of successive processing steps not to be carried out for all of the plants transported on the conveyor device, but rather only for those for which appropriate processing has been specified.

Alternatively, it is also conceivable for the conveyor device to be assigned two, three or more, in particular different processing means and for a plurality of plants to be processed simultaneously by said processing means. This parallel processing of a plurality of plants by means of one processing tool each can significantly improve both the time efficiency and the cost structure of the process. A development may make provision for a plurality of plants on a plurality of parallel conveyor devices to be processed in parallel and simultaneously by a plurality of processing means or for a plurality of plants on a plurality of parallel conveyor devices to be processed successively by a processing means.

Preferably, it is conceivable for the processing means for processing the plant, in particular a tool of the processing means, to be at least partially moved with the plant lying on the conveyor device. This synchronized movement of the tool with the plant allows continuous transport of the plant by the conveyor device. This continuous movement of the conveyor device leads to a particularly efficient processing of the plant in terms of time. Since the tool of the processing means is hinged on a robot arm, the tool can easily at least partially follow the movement of the plant.

In the exemplary embodiment in which the processing means is designed as a laser, the focus of the laser can be manipulated in such a way that it moves with the plant on the conveyor device. This allows the maximum radiation intensity of the laser to be generated precisely on the plant. The guiding of the focus is carried out, for example, by guiding a plurality of mirrors. This synchronized guiding of the mirrors allows the laser to be guided over large sections with the plant.

Alternatively, it is also conceivable for the conveyor device to be operated continuously or periodically or cyclically, wherein the conveyor device is briefly stopped during the periodic or cyclic operation of the conveyor device for processing the plant. This cyclic stopping is synchronized with the processing of at least one plant by at least one processing means. However, it is also conceivable that each time the conveyor device is stopped, a multiplicity of processing means processes one plant each. This cyclic operation of the conveyor device means that it is not necessary to guide the processing means. At the same time, a high throughput rate of processed plants can be achieved.

The processing of the plant may involve cutting the plant, cloning, sampling, meristemization, micrografting, selective processing of the plant tissue, growth stimulation, irradiation of the plant for bioactivation and/or pathogen elimination, disruption of the dormancy by perforating a seed coat, processing and treatment of seeds, seed coats, embryos, zygotes, proembryos, processing and treatment of plant organs for in vitro culture, such as meristem, axillary buds, root tips, leaf and peduncle pieces, adventitious shoots, callus cultures, solitary cells, microspores, ovaries, anthers, pollen, fruits and microcuttings, treatments against bacteria and fungal spores or the like. In addition, it is also conceivable for even further processing of the plants or plant components to be carried out by means of the method described here.

Finally, the invention may also make provision that the processing of the plant takes place in a sterile or in a non-sterile environment, wherein the at least one plant is transported automatically into the sterile environment and automatically out of the sterile environment again. For example, the method described here can be carried out in an open manner, i.e. in a normal room atmosphere, if the processing of the plant permits this. However, if necessary, the method may also be completed in a room which can be sterilized. This room must be sterilized regularly or after each processing or after each processing step. To prevent germs and the like from being introduced into this room, an appropriate lock system can be connected upstream. Before entry into the processing room, the plant and possibly the container in which the plant is transported are sterilized. In this way, the present method is able not only to increase the efficiency in terms of costs and time, but also to achieve a very high plant processing quality.

Preferred exemplary embodiments of the invention will be described in more detail below with reference to the drawing. In the drawing:

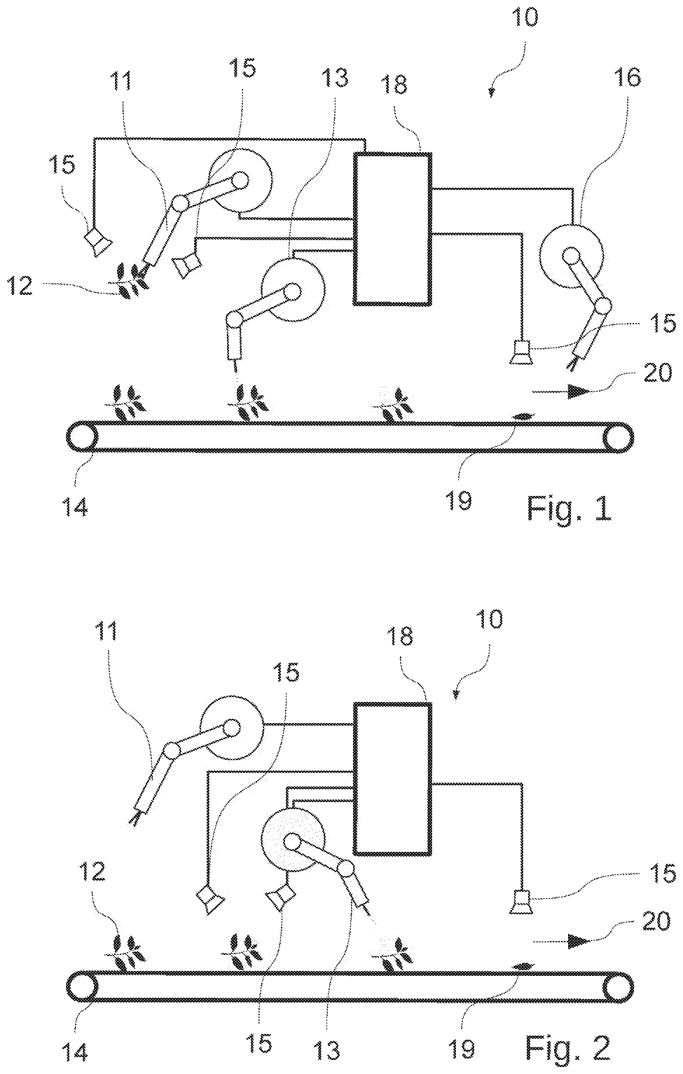

FIG. 1 shows an illustration of a first exemplary embodiment of an apparatus,

FIG. 2 shows an illustration of a second exemplary embodiment of the apparatus,

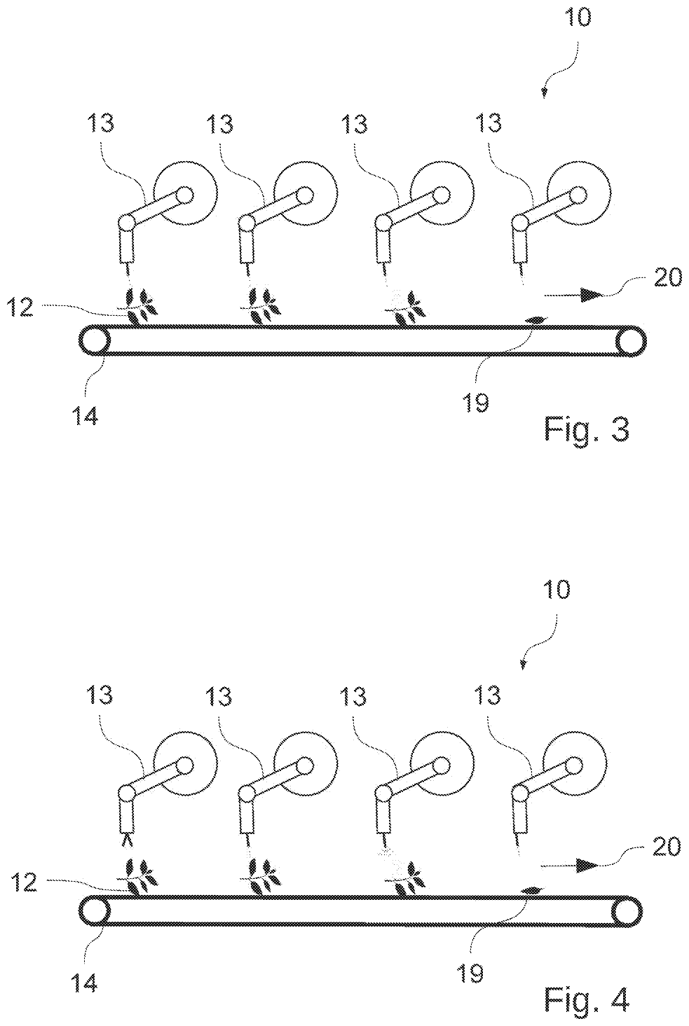

FIG. 3 shows an illustration of a third exemplary embodiment of the apparatus,

FIG. 4 shows an illustration of a further exemplary embodiment of the apparatus,

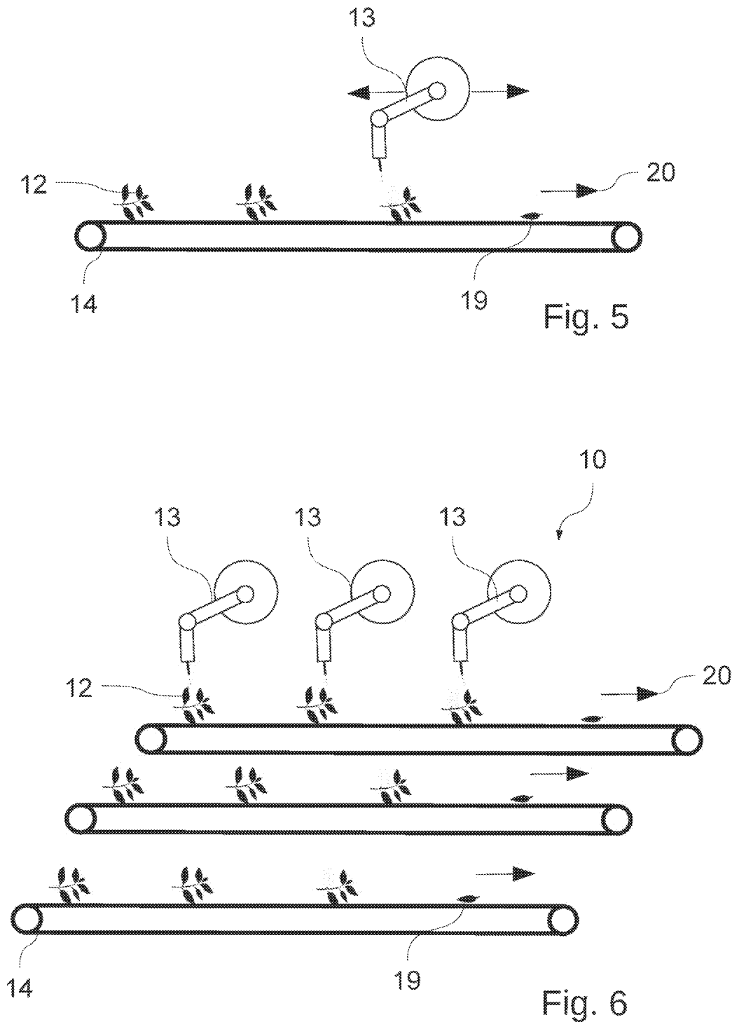

FIG. 5 shows an illustration of a further exemplary embodiment of the apparatus, and

FIG. 6 shows an illustration of a further exemplary embodiment of the apparatus.

The exemplary embodiment of an apparatus 10 for carrying out the method according to the invention illustrated in FIG. 1 essentially comprises a gripping means 11 for grasping a plant 12, a processing means 13 and a conveyor device 14. In addition, the apparatus 10 has an image recognition device, which comprises three cameras 15 in the exemplary embodiment illustrated here. Optionally, it is conceivable that this exemplary embodiment has a further gripping means 16, which is assigned to an end portion 17 of the conveyor device 14. Finally, the apparatus 10 comprises a control unit 18, in which the control of the gripping means 11, 16 of the processing means 13 and of the conveyor device 14 and also the image recognition can be integrated.

The gripping means 11, 16 have a gripper for grasping the plant 12. Said gripper can be tweezers, a clamping device or a suction device. The gripper should be designed in such a way that the plant 12 is not or is not substantially damaged when it is grasped.

The gripper has a robot arm with which it can be moved with pinpoint accuracy three-dimensionally. Thus, the gripper can reach at least almost any area in the vicinity of the cameras 15 and the conveyor device 14.

The processing means 13 illustrated by way of example in FIG. 1 is a tool which is movably mounted three-dimensionally via a robot arm. Said tool can be, for example, scissors, a scalpel, a hot wire, a laser beam, a plasma jet, a water jet, tweezers, pliers, a spatula or the like. This tool allows the plant or a component of the plant to be processed. Depending on the choice of tool or the type of tool, a wide variety of processes can be carried out on the plant. In the exemplary embodiment in which the processing means 13 is formed as a laser, it may be provided that the laser is not fastened to a robot arm as shown here, but rather is freely movable via a mirror system. The focus is moved in such a way that the focal area coincides with the plant or the corresponding plant component.

The further gripping means 16 is identical to or at least designed similarly to the gripping means 11. However, it is also conceivable for the further gripping means 16, in contrast to the gripping means 11, to be designed for detecting individual components 19 of the plant 12.

The conveyor device 14 illustrated by way of example in FIG. 1 may also be a belt conveyor, a wire belt conveyor, a steel or metal wire belt conveyor or the like. Similarly, it is also conceivable for the conveyor device 14 to be designed as a discontinuous conveyor. The conveyor device 14 may also be a tray or a multiplicity of individual trays. The upper strand or the surface of the conveyor device 14 is designed in such a way that it is not damaged by irradiation of a laser. In addition, the surface of the conveyor device 14 can be sterilized, and therefore the plants 12 can always be processed germ-free on the conveyor device 14.

According to the invention, it can be provided that the type or certain patterns or features of the plant 12 are determined by means of an artificial intelligence (AI) neural network. For this purpose, images of the plant 12 are recorded by the cameras 15 and compared with known images. The neural network then determines positions on the plant 12 that are particularly suitable for the processing of the plant 12 or it is determined which processes can be carried out particularly well on this plant. For recording the images, the plant 12 is first of all grasped by the gripping means 11.

Corresponding image recognition can be used even during the targeted grasping of the plant 12. The plant 12 may be located in a container with a culture medium before being grasped by the gripping means 11. However, the plant 12 can just as readily lie freely on a substrate or on a tray. Alternatively, it is conceivable for the plant 12 to be fed by a person to the gripping means 11. In the next step, the gripping means 11 feeds the plant 12 to the cameras 15 in such a way that at least one recording of the plant 12 for further image recognition can be recorded. Depending on the identified features and patterns, the plant 12 is then deposited by the gripping means 11 onto the conveyor device 14 in such a way that the processing means can directly process the plant 12. In the exemplary embodiment illustrated in FIG. 1, this may involve cutting by means of a laser. The plant 12 is deposited on the conveyor device 14 in such a way that the laser cut can be set particularly easily and thus reliably and efficiently in terms of time. The remaining plant and/or the component 19 of the plant can then be discharged in the transport direction 20 and optionally detected by a further camera 15, so that the further gripping means 16 grasps the plant 12 or the plant component 19 from the conveyor device 14 and feeds same to the next method step. The next method step may be, for example, planting in a culture medium.

After the plant processing has been carried out or at regular intervals, the aforementioned tools and/or devices should be sterilized. No sterilization is required if the type of plant or the type of treatment permits this.

The exemplary embodiment illustrated in FIG. 2 differs from the exemplary embodiment of FIG. 1 in that the plant 12 is deposited directly on the conveyor device 14 by the gripping means 11 and only then is detected by the image recognition device. For this purpose, the cameras 15 are directed onto the conveyor device 14 in such a way that the plant 12 can be recorded as comprehensively as possible. The advantage of this exemplary embodiment is that the gripping means 11 does not first have to stop in its movement so that a recording of the plant 12 can be created by the cameras 15. On the contrary, the gripping means 11 can carry out a continuous, flowing movement from grasping to depositing of the plant 12. This further shift of the image recognition to the conveyor device 14 can further increase the efficiency of the method in terms of time.

In the exemplary embodiments of the invention illustrated in FIGS. 3 and 4, provision is made for the conveyor device 14 to be assigned a plurality of processing means 13. The other features not illustrated in FIGS. 3 and 4 may correspond to those of the exemplary embodiments according to FIG. 1 or FIG. 2. In the exemplary embodiment according to FIG. 3, all of the processing means 13 have the same tool, namely a laser. The depositing as well as the image recognition are undertaken here in the same way as previously illustrated with reference to the exemplary embodiments according to FIGS. 1 and 2. The advantage in the case of the exemplary embodiment according to FIG. 3 consists in that the same plant 12 is processed successively by a plurality of processing means 13, each processing means 13 being positioned at a different position. This station-like or step-by-step processing of the plant 12 allows complex processing to be carried out efficiently in terms of time. An alternative exemplary embodiment may make provision for a plurality of different plants 12 which are each processed once by a processing means 13 to be positioned on the conveyor device 14.

In the exemplary embodiment according to FIG. 4, provision is made for the processing means 13 to each have a different tool. Thus, different processing steps or operations that are complementary or independent of one another can be carried out in succession on the plant 12. This cascade-like processing allows the plant to be deposited once in a targeted manner and then processed in a diverse and complex manner to achieve the optimum result. An optimum result would be, for example, a multiple cloning of the plant 12 with particularly sterile cutting surfaces, with individual clones growing particularly rapidly because of corresponding irradiation.

In the exemplary embodiments according to FIGS. 1 to 4, it is conceivable for the conveyor device 14 to be stopped at least briefly for each processing, so that the processing means 13 can process the plant 12 in the most precise way possible. For example, a particularly precise cut can be achieved by means of a scalpel, if the relative speed between the plant 12 and the processing means 13 is 0 m/s. As an alternative, it is also conceivable for the processing means 13 to at least briefly move simultaneously with the conveyor device 14. A corresponding exemplary embodiment is illustrated in FIG. 5 in highly schematized form. Here, too, the features which are not illustrated coincide with the exemplary embodiments according to FIG. 1 or according to FIG. 2. The processing means 13 is mounted in such a way that it moves simultaneously with the plant 12 on the conveyor device 14. This simultaneous movement usually takes place only for a few seconds or for a fraction of a second. In addition to the movement of the entire processing means 13, a guiding of the robot arm or the tool is also conceivable. In the exemplary embodiment of a laser, it is also conceivable for the focus of the laser to be movable by a corresponding mirror system. Thus, the focus can be moved simultaneously with the plant 12 by corresponding activation of the mirrors.

Finally, FIG. 6 illustrates an exemplary embodiment in which a plurality of conveyor devices 14 are operated in parallel to one another. The same methods can be carried out and the same devices, as previously described with reference to the exemplary embodiments according to FIGS. 1 to 5, can be used on these conveyor devices 14. In this exemplary embodiment according to FIG. 6, a multiplicity of plants 12 can be treated by a processing means or by a multiplicity of processing means 14 simultaneously, or successively with the same or different tools. This exemplary embodiment may also make provision for plants 12 to be moved from one conveyor device 14 to another conveyor device 14 for finishing work. For example, it is conceivable for each conveyor device 14 to be assigned a special processing means 13. In addition, it is conceivable for the conveyor devices 14 to be operated at different speeds such that, for example, plants 12, the processing of which has already been completed, are fed on a fast-moving conveyor device 14 for further processing.

Each of the exemplary embodiments of the apparatus 10 according to FIGS. 1 to 6 that are illustrated here can either stand open in the room or be enclosed by a housing so that a sterile atmosphere can be formed within the housing. For less sensitive plants, the outlay on processing can thus be kept relatively low and the method can be carried out in the open room. Plants requiring greater sterility during processing have to be processed in an appropriate atmosphere. The plant 12 can be fed into and discharged from this room automatically or manually.

### LIST OF REFERENCE SIGNS

10 Apparatus
11 Gripping means
12 Plant
13 Processing means
14 Conveyor device
15 Camera
16 Gripping means
17 End section
18 Control unit
19 Component
20 Direction of transport

1. An apparatus for processing at least one plant, having at least one conveyor device for transporting the plant, at least one image recognition device, at least one gripping means for the targeted depositing of the at least one plant on the conveyor device, and at least one processing means for processing the plant lying on the conveyor device.

2. The apparatus as claimed in claim 1, wherein the image recognition device has at least one camera for recording a 2D or 3D image of the plant, and wherein the image recognition device has a neural network or an algorithm, by which the plant as well as individual components and features of the plant can be recognized and, on the basis of the recognized patterns and features of the plant, the plant can be deposited in a targeted manner on the conveyor device by the gripping means and can be processed by the processing means.

3. The apparatus as claimed in claim 1, wherein the processing means has at least one tool, namely scissors, a scalpel, a hot wire, a laser beam, a plasma jet, a water jet, tweezers, pliers, a spatula or the like, wherein the tool is selectively movable three-dimensionally.

4. The apparatus as claimed in claim 1, wherein the conveyor device is a belt conveyor, wherein the material of the conveyor device reflects electromagnetic radiation and/or is permeable for a fluid.

5. The apparatus as claimed in claim 1, wherein the processing means is movable at the same time relative to the conveyor device, wherein the relative speed of the tool to the plant during the processing of the plant is 0 m/s.

6. The apparatus as claimed in claim 1, wherein the processing means is a laser, the focus of which can be concentrated on the plant transported on the conveyor device.

7. The apparatus as claimed in claim 1, wherein a plurality of processing means are arranged on the conveyor device in order to carry out successive processing steps on the plant and/or to simultaneously process a plurality of plants in parallel.

8. The apparatus as claimed in claim 1, wherein at least one further gripping means is arranged at one end of the conveying device in order to grasp the processed plant or a component of the plant in a targeted manner and to supply same to a further processing step and/or to sort the processed plant or a component of the plant.

9. The apparatus as claimed in claim 1, wherein the apparatus has a sterile or non-sterile processing space in which the at least one conveyor device, the at least one image recognition device, the at least one gripping means and the at least one processing means are arranged, wherein the sterile processing space has at least one introduction lock and at least one discharge lock.

10. The apparatus as claimed in claim 1, wherein a plurality of parallel conveyor devices, which can be operated at the same or different speeds, each transport at least one plant, which can be individually processed by a plurality of processing means.

11. A method for processing at least one plant, wherein the at least one plant is detected by an image recognition device in order to recognize patterns and features of the plant, and wherein the plant is deposited by a gripping means in a targeted manner on a conveyor device for transporting the plant and is processed lying on the conveyor device by at least one processing means.

12. The method as claimed in claim 11, wherein images of the plant are recorded by at least one camera of the image recognition device, and a neural network or an algorithm on the basis of the images is used to determine positions on the plant at which processing by the processing means can be carried out particularly efficiently, wherein the plant is held by the gripping means during the recording of the images or is already lying on the conveyor device.

13. The method as claimed in claim 12, wherein the plant is deposited on the conveyor device by the gripping means, depending on the position determined by the neural network, specifically in such a way that the plant can be processed directly and optimally by the processing means.

14. The method as claimed in claim 12, wherein a plurality of plants are deposited by the gripping means next to one another on the conveyor device, depending on the position determined by the neural network, specifically in such a way that the plurality of plants can be processed directly and optimally in one process step by the processing means.

15. The method as claimed in claim 11, wherein the conveyor device is assigned two, three or more processing means and a plant which is transported on the conveyor device is processed successively by the processing means.

16. The method as claimed in claim 11, wherein the conveyor device is assigned two, three or more processing means and a plurality of plants are processed simultaneously by the processing means.

17. The method as claimed in claim 11, wherein the processing means for processing the plant, is at least partially moved at the same time with the plant, which is lying on the conveyor device.

18. The method as claimed in claim 11, wherein a focus of a laser which is used as a processing means is moved with the plant, which is lying on the conveyor device, such that the maximum radiation intensity is directed onto the plant.

19. The method as claimed in claim 11, wherein the conveyor device is operated continuously or periodically or cyclically, wherein the conveyor device is briefly stopped during the periodic or cyclic operation of the conveyor device for processing the plant.

20. The method as claimed in claim 11, wherein a plurality of plants on a plurality of parallel conveyor devices are processed in parallel and simultaneously by a plurality of processing means or a plurality of plants on a plurality of parallel conveyor devices are processed successively by a processing means.

21. The method as claimed in claim 11, wherein the processing of the plant involves cutting the plant, cloning, sampling, meristemization, micrografting, selective processing of the plant tissue, growth stimulation, irradiation of the plant for bioactivation and/or pathogen elimination, disruption of the dormancy by perforating a seed coat, processing and treatment of seeds, seed coats, embryos, zygotes, proembryos, processing and treatment of plant organs for in vitro culture, such as meristem, axillary buds, root tips, leaf and peduncle pieces, adventitious shoots, callus cultures, solitary cells, microspores, ovaries, anthers, pollen, fruits and microcuttings, treatments against bacteria and fungal spores and/or a sorting process or the like.

22. The method as claimed in claim 11, wherein the plurality of plants are sorted according to type and quality, quantity, amount, shape, size or the like.

23. The method as claimed in claim 11, wherein the processing of the plant takes place in a sterile or in a non-sterile environment, wherein the at least one plant is transported automatically into the sterile environment and automatically out of the sterile environment again.
